(19) United States
(12) Patent Application Publication
(10) Pub. No.: US 2015/0153486 A1
(43) Pub. Date: Jun. 4, 2015

(54) FRESNEL LENS OPTICAL ALIGNMENT SYSTEM

(71) Applicant: LOCKHEED MARTIN CORPORATION, Bethesda, MD (US)

(72) Inventor: Bryan Neal FISK, Madison, AL (US)

(21) Appl. No.: 14/503,744

(22) Filed: Oct. 1, 2014

Related U.S. Application Data
(60) Provisional application No. 61/885,142, filed on Oct. 1, 2013.

(51) Int. Cl. G02B 3/08; B60Q 9/00

(52) U.S. Cl. CPC G02B 3/08; B60Q 9/002

(57) ABSTRACT

An optical alignment system is provided that simplifies the alignment of two vehicles, for example during a docking procedure, and provides visual cues indicating range to prevent accidental collision. The optical alignment system includes a horizontal array of Fresnel lenses including a first plurality of Fresnel lenses disposed on one side of a vertical axis and a second plurality of Fresnel lenses disposed on the opposite side of the vertical axis. One Fresnel lens of the first plurality and one Fresnel lens of the second plurality are spaced equidistant from the vertical axis and form a first pair, and the Fresnel lenses of the first pair are arranged so that light paths therefrom converge along the vertical axis at a first distance behind the horizontal array of lights.

### FIELD

This technical disclosure relates to systems and methods for facilitating or aiding the alignment of a first vehicle with a second vehicle, for example during docking of the first vehicle with the second vehicle, using an optical alignment system.

### BACKGROUND

A Fresnel Lens Optical Landing System (FLOLS) and Improved Fresnel Lens Optical Landing System (IFLOLS) are known optical alignment systems which are used for landing of aircraft on aircraft carriers and land-based landing strips. An example of a FLOLS 2 is illustrated in FIG. 8. The FLOLS 2 includes a horizontal row of datum lights 4 in the form of green lamps which are used to give the pilot a reference against which he may judge his position relative to the glide slope. The FLOLS 2 also includes a vertical array of Fresnel lenses 6. Depending upon the height of the aircraft, the pilot will be able to observe a single light (often termed the “meatball”) from the vertical array 6. By comparing the visible light's (or meatball's) location with respect to the datum lights 4, the pilot knows the position of the aircraft with reference to the glide slope. If the aircraft is high, the visible light from the array 6 will be above the row of datum lights 4; if the aircraft is low, the visible light from the array 6 will be similarly below the row of datum lights 4; if the aircraft is at the correct height, the visible light from the array 6 will coincide with the row of datum lights 4.

FLOLS and IFLOLS are able to provide glide slope information for aircraft landings, but are inadequate for aligning a first vehicle with a second vehicle that are already generally at the same vertical height in order to dock the two vehicles.

### SUMMARY

An alignment system and method are described that facilitates the alignment of a first vehicle with a second vehicle, for example during docking of the first vehicle with the second vehicle. The system and method utilizes an optical alignment system that simplifies the alignment of the two vehicles and provides visual cues indicating range to prevent accidental collision.

The term “docking” as used herein includes maneuvering the first vehicle relative to the second vehicle to properly position the first vehicle and once positioned, securing the first vehicle to the second vehicle. The two vehicles are substantially at the same vertical height. The docking can be temporary in that the first vehicle is intended to be released from the second vehicle after some period of time, or the docking can be considered non-temporary, for example for the purposes of retrieving the first vehicle by the second vehicle. The first vehicle can be disposed in the water or disposed on land prior to and/or after docking. The second vehicle also can be disposed in the water or disposed on land prior to and/or after docking.

The alignment system and method can be used in any application where a first vehicle needs to be aligned with a second vehicle, for example when docking the first vehicle with the second vehicle. For example, the first vehicle can be a manned or unmanned underwater vehicle, a manned or unmanned surface water vehicle, a manned or unmanned land vehicle, or a manned or unmanned space vehicle. The second vehicle can be a floating refueling sled to which the first vehicle needs to align to fuel the first vehicle, a water-borne vessel that is designed to retrieve the first vehicle while the vessel remains in the water, a trailer on which the first vehicle aligns and docks to remove the first vehicle from water, a space vehicle, or the like.

The system and method described herein will benefit aligning of any two vehicles, for example at-sea vessels, for example commercial, military and private vessels. The optical alignment system provides a simple visible interface that will provide the necessary information in an easy to understand format that makes alignment simple for even novices. For example, a cruise ship that has the optical alignment system installed can decrease their insurance liability when they allow tourists to take out a small water vessel, such as a personal water craft or small motor boat, which will have to be aligned and re-docked. Private boaters can install a simple portable version on their boat trailer so that they know they're aligned correctly before docking. The military can use this with various vessels, such as remote vehicles and unmanned submersed vehicles.

The optical alignment system uses Fresnel lenses to constrain the visibility of a series of lights. Keeping a certain light(s) in view ensures that the approaching vehicle is properly aligned. In one embodiment, when multiples of other lights are visible simultaneously the approaching vehicle is at the proper range relative to the receiving vehicle.

In one embodiment, the optical alignment system can be mounted on the receiving vehicle that is to receive the docking vehicle. The optical alignment system can include a vertical strip of lights that, in one embodiment, indicates the centerline of the receiving vehicle. There is also a horizontal strip of lights comprising Fresnel lenses. There can also be two flashing red lights on opposite sides (horizontal aspect) of the vertical strip of light which use Fresnel lenses. The light paths of these two flashing lights can be arranged to converge at a particular distance behind, but along the centerline, of the receiving vehicle, with the convergence location indicating a safe position to initiate further docking procedures.

Depending on the angle, to either side of the centerline, that the docking vehicle is at, the docking vehicle will only be able to observe a single light on the horizontal strip. By comparing the light's location with respect to the vertical alignment strip, the docking vehicle can determine the approximate error in alignment with the receiving vehicle centerline. When the two vehicles are properly aligned, the visible light from the horizontal strip will align with the vertical strip.

In addition, as the docking vehicle approaches the receiving vehicle, it will encounter the flashing red lights. If only a single red light is visible then the vehicle is off to one side of the centerline (correspondingly, the visible light from the horizontal strip will not be in alignment either). If the visible light is in alignment, as the docking vehicle closes in range both red lights will be visible simultaneously at the range where it is safe/possible to, for example, catch a retrieval line trailing behind the receiving vehicle.

In another embodiment, there could alternately be four red or other color lights grouped in pairs that are visible at different ranges from the receiving vehicle. The first pair could be steady-on lights indicating the docking vehicle is in the right position to dock while the second pair could be flashing lights that may only be visible (simultaneously, again) if the vehicles are too close and a collision is imminent (keep out zone).

In another embodiment, the vertical strip of lights is optional (the vertical strip of lights may be useful, but not necessary in all embodiments). Instead, each pair of lights on the horizontal strip that are equally distant from a centerline, for example designating the receiving vehicle's centerline, have their Fresnel lenses aligned so that these lights intersect only at a particular range behind the receiving vehicle (similar to how the red lights are arranged, but with the pairs of lights having unique intersection ranges). When the docking vehicle is not aligned with the centerline, only one of the pair will be visible. There will normally be two lights visible at all times, but if the lights are not equidistant from the centerline, then the docking vehicle is off from center. For example, if there are two lights visible, for example the 5th on the left and the 4th on the right, then the docking vehicle is too far to the left. Once back on center, the docking vehicle will see the 4th light on the left and the 4th on the right.

In another embodiment, an optical alignment system that aligns a first vehicle with a second vehicle includes a horizontal array of Fresnel lenses including a first plurality of Fresnel lenses disposed on one side of a vertical line and a second plurality of Fresnel lenses disposed on the opposite side of the vertical line. One Fresnel lens of the first plurality and one Fresnel lens of the second plurality are spaced equidistant from the vertical line and form a first pair, and the Fresnel lenses of the first pair are arranged so that light paths therefrom converge along the vertical line at a first distance behind the horizontal array of lights.

In another embodiment, an optical alignment system for aligning a first vehicle with a second vehicle includes a horizontal array of Fresnel lenses mounted on the second vehicle so as to be visible to the first vehicle. The horizontal array includes a first plurality of Fresnel lenses disposed on one side of a vertical axis and a second plurality of Fresnel lenses disposed on the opposite side of the vertical axis. One Fresnel lens of the first plurality and one Fresnel lens of the second plurality form a first pair, one Fresnel lens of the first plurality and one Fresnel lens of the second plurality form a second pair, and one Fresnel lens of the first plurality and one Fresnel lens of the second plurality form a third pair. In addition, one or more of the following features applies:

a) each Fresnel lens of the first plurality and each Fresnel lens of the second plurality emit coded light that is human or machine readable;

b) the first pair of Fresnel lenses, the second pair of Fresnel lenses, and the third pair of Fresnel lenses are arranged so that light paths from each pair converge at respective convergence locations along a common axis, the convergence locations are at different distances behind the horizontal array.

On the horizontal strip or array of Fresnel lenses, left from right can be distinguished from one another in any suitable manner, for example by color or by light shape (e.g. vertical vs. horizontal rectangle, or square vs. circle). The count to either side (e.g. the position of the visible Fresnel lens to the left or right of the vertical axis) can be identified by, for example, by using a central, vertical alignment bar, by illuminating the location of every light (could be done with a ring of white LEDs around the edge of each light such that when the light is visible (the Fresnel lens permits viewing from that angle) the center of that ring will glow), or by having the various lights be shaped as numbers in a man/machine readable format.

The lights could also flash an encoded message indicating its position relative to the centerline. For example, the fifth light on the left could flash a code saying it is the 5th light on the left; etc. The code could be a machine interpretable code or could even be done with Morse code.

Therefore, as used herein, the coded light that is human or machine readable is considered to include, but is not limited to, emitting differently colored light depending upon the location of the Fresnel lenses from the vertical axis (the differently colored lights are visually distinguishable by the human eye whether the lights are being viewed by a person on the docking vehicle or whether the lights are being viewed by a person via a camera mounted on the docking vehicle; the different colored lights can also be detected using a color photodetector); the Fresnel lenses emitting flashing light in the form of a code (the flashing light can be interpreted/read by a human or by a machine); the Fresnel lenses can have different shapes depending upon their location from the vertical axis (the shapes can be interpreted/read by a human or by a machine); by combinations thereof; or by any other means that permits distinguishing the Fresnel lenses in the horizontal array from one another.

The optical alignment system described herein can be used by any two vehicles that need to align with one another for any reason. For example, the vehicles could dock with one another for the purposes of refueling, data transfer from one vehicle to the other, repairing the docked vehicle, transferring materials, supplies and/or personnel from one vehicle to the other, and the like.

Advantages of the optical alignment system include, but are not limited to:
the use of crossed light fields (viewability controlled via Fresnel lenses) to indicate distance between two vehicles;
the use of crossed light fields indicates alignment of two vehicles;
Fresnel lens lighting system used for single-point visual cuing of docking at-sea vehicles; and
use of Fresnel lenses to indicate azimuthal alignment between two vehicles.

The lights on either the horizontal array and/or the vertical strip (if used) do not have to be within the visible spectrum if secrecy is a concern in military applications.

### DRAWINGS

FIG. 1 is a rear view of a receiving vehicle, as seen by a docking vehicle, that includes an embodiment of an optical alignment system described herein.

FIG. 2 is a top view of the receiving vehicle showing one example of light paths from the Fresnel lenses in the horizontal array.

FIGS. 3A, 3B and 3C illustrate examples of light arrangements seen by the docking vehicle when the docking vehicle is off-center right (FIG. 3A), off-center left (FIG. 3B), and on-center (FIG. 3C).

FIG. 4 is a rear view of a receiving vehicle, as seen by a docking vehicle, that includes another embodiment of an optical alignment system described herein.

FIG. 5 is a top view of the receiving vehicle of FIG. 4 showing another example of light paths from the Fresnel lenses in the horizontal array.

FIG. 6 is a top view of one example of a receiving vehicle that can incorporate the optical alignment systems described herein.

FIGS. 7A, 7B and 7C illustrate different stages of a docking vehicle aligning an docking with the receiving vehicle of FIG. 6.

FIG. 8 illustrates a known optical landing system.

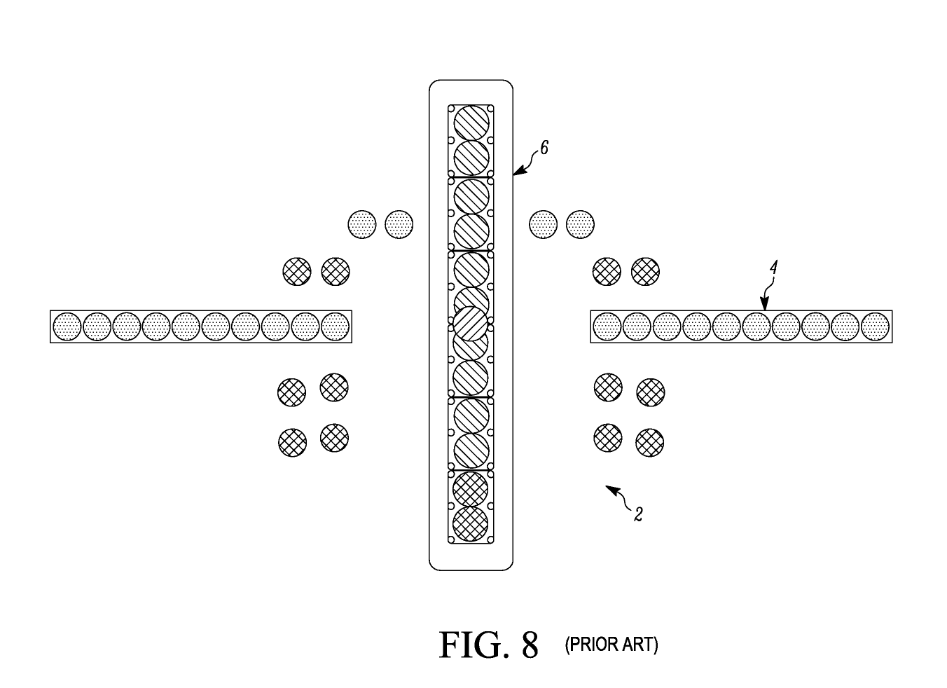

### DETAILED DESCRIPTION

A docking system and method are described that facilitates the alignment of a first or docking vehicle with a second or receiving vehicle. The system and method utilizes an optical alignment system that simplifies the alignment of the two vehicles, for example during docking of the two vehicles, and provides visual cues indicating range to prevent accidental collision.

To facilitate explanation of the various embodiments described herein, the two vehicles will be described as water-based vehicles. In particular, the first or docking vehicle will be described as being a Remote Multi-Mission Vehicle (RMMV) such as an Autonomous Unmanned Vehicle (AUV), an Unmanned Surface Vehicle (USV), an Unmanned Underwater Vehicle (UUV), a manned vehicle such as manned submersible, or the like. The second or receiving vehicle will be described as being a refueling craft that is designed to refuel the first vehicle once the first vehicle is docked with the second vehicle. In this example, the first vehicle is considered docked with the second vehicle when the two vehicles are secured together in a manner that permits fuel transfer to occur between the two vehicles.

The embodiments described herein are not limited to docking of water-based vehicles, and not limited to refueling of the first vehicle by the second vehicle. The concepts described herein can be applied to aligning any two vehicles operating in any environment, e.g. under the water, in the water, on land, in the air, in space, etc., where it is desired to align one vehicle with a second vehicle for any reason.

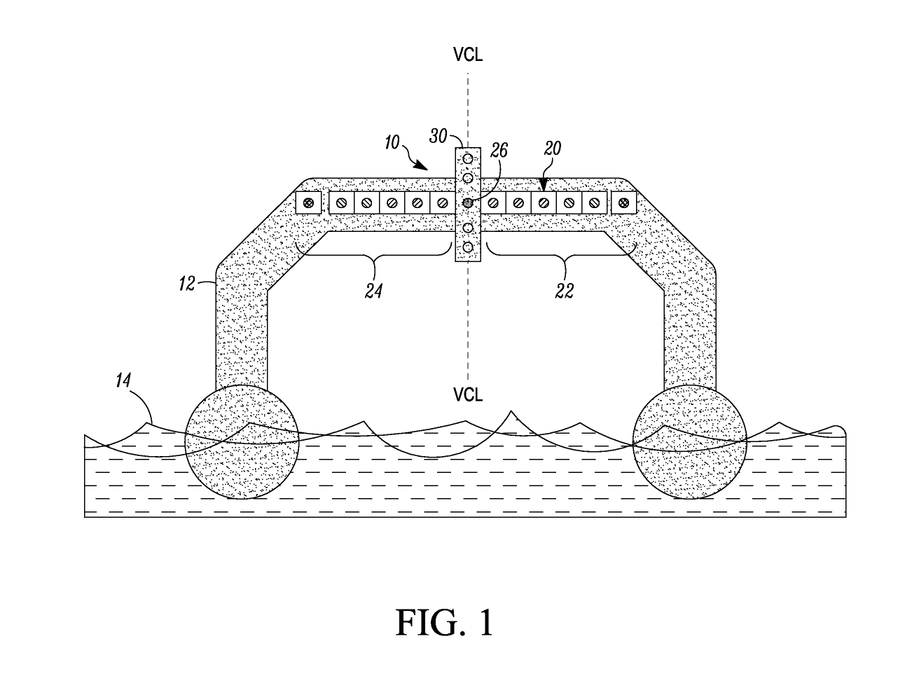

With reference initially to FIGS. 1-3, an optical alignment system 10 that is mounted on a receiving vehicle 12 is illustrated. The system 10 is mounted on the vehicle 12 in any suitable location so that the system 10 is visible to the docking vehicle that will dock with the vehicle 12. In the illustrated embodiment, the system 10 is mounted on a portion of the vehicle that is disposed above a waterline 14. The system 10 can be disposed on the vehicle 12 so that the system 10 is oriented to face in the aft or rearward direction in the case of the docking vehicle being docked with the vehicle 12 by approaching from the aft. Alternatively, the system 10 can be disposed on the vehicle 12 so that the system is oriented to face in the fore or forward direction in the case of the docking vehicle being aligned with the vehicle 12 by approaching from the front. The system 10 can also be oriented to face in port or starboard directions, or at any orientation facing the direction at which the docking vehicle is intended to approach the vehicle 12 during alignment and subsequent docking.

In addition, the system 10 is illustrated as being disposed along a vertical centerline VCL of the vehicle, which in the illustrated example is along a longitudinal centerline LCL of the vehicle. The VCL is just one example of a vertical line along which the system 10 can be disposed. The system 10 can be disposed along any vertical line of the vehicle not necessarily along the longitudinal centerline LCL.

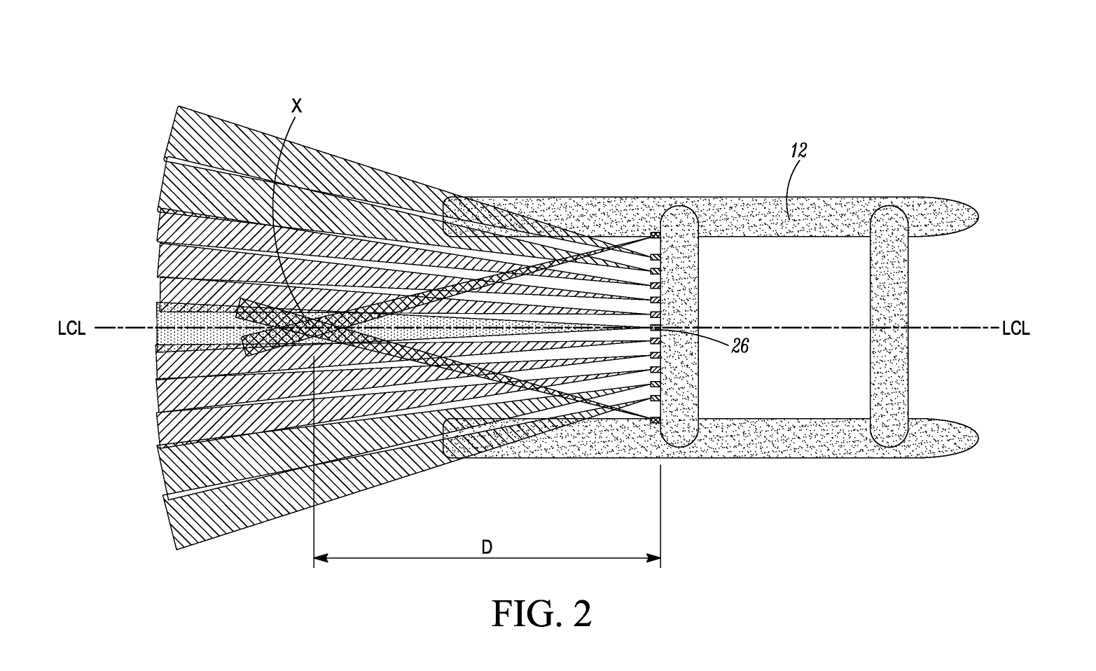

As best seen in FIGS. 1 and 2, the system 10 includes a horizontal array 20 of Fresnel lenses that, in the illustrated example, are linearly arranged along a horizontal axis. The array 20 includes a first plurality 22 of Fresnel lenses disposed on one side of the vertical centerline VCL (for example the right side) and a second plurality 24 of Fresnel lenses disposed on the opposite side of the vertical centerline VCL (for example the left side). In addition, one Fresnel lens 26 of the array 20 is disposed on the vertical centerline VCL.

The Fresnel lenses of the array 20 are arranged in pairs, with one Fresnel lens of the first plurality 22 and one Fresnel lens of the second plurality 24 spaced equidistant from the vertical centerline VCL to form a first pair; one Fresnel lens of the first plurality 22 and one Fresnel lens of the second plurality 24 spaced equidistant from the vertical centerline VCL to form a second pair; etc. In the illustrated example, there are 6 pairs of Fresnel lenses so that, together with the Fresnel lens 26, there are 13 total Fresnel lenses. However, a larger or smaller number of Fresnel lenses and Fresnel lens pairs can be used.

Each Fresnel lens includes an associated light emitting element (not illustrated), such as a light emitting diode (LED), incandescent bulb, or the like, that provides the light that is directed through and from the Fresnel lens.

With reference to FIG. 1, the Fresnel lens 26 on the VCL will be referred to as the center lens. For the arrays 22, 24, the Fresnel lenses in each array can be referred to by their respective positions to the right or left of the VCL. For example, the 1^{st} Fresnel lens to the right of the VCL can be termed R1, the 2^{nd} to the right as R2, etc., while the 1^{st} Fresnel lens to the left of the VCL can be termed L1, the 2^{nd} to the left as L2, etc.

With reference to FIG. 2, the Fresnel lenses of at least one of the pairs are arranged so that light paths therefrom converge along the longitudinal centerline LCL at a first distance D behind the array 20. In the illustrated example, it is the R6, L6 pair of Fresnel lenses that are arranged so that their light paths converge at position X. The Fresnel lenses of the remaining pairs (R1, L1; R2, L2; R3, L3; R4, L4; R5, L5) are arranged so that light paths therefrom diverge from one another and diverge from the LCL. The center lens 26 is arranged so that the light path therefrom extends along the LCL. Each Fresnel lens creates a cone of light so that only one Fresnel lens is visible at any one time unless in proper position at X in which case both lenses R6, L6 are visible.

In one embodiment, the Fresnel lenses of the pairs can have different colors which can indicate to a docking vehicle an angular position relative to the LCL of the vehicle 12. For example, the center lens 26 can have a green color which can be constant or flashing. By keeping the green light visible, the docking vehicle knows that it is aligned with the vehicle 12 along the LCL in proper position.

The R1, L1; R2, L2; and R3, L3 pairs can have, for example, a blue color which can be constant or flashing. If the docking vehicle sees one of the blue lights, the docking vehicle knows that it is close to center, but off set from the LCL either to the right or the left.

The R4, L4; R5, L5 pairs can have, for example, a yellow or amber color which can be constant or flashing. If the docking vehicle sees one of the yellow or amber lights, the docking vehicle knows that it is dangerously off set from the LCL either to the right or the left.

The converging R6, L6 pair can have, for example, a red color which can be constant or flashing. When both red lights are visible, the docking vehicle knows that it is at the correct position, for example for subsequent docking.

As used herein, the Fresnel lenses having different colors can be achieved by the Fresnel lenses themselves being colored to change white light emitted by its associated light emitting element to the desired color. In another embodiment, the Fresnel lenses can be uncolored and instead the color is produced by its associated light emitting element. In another embodiment, the different colors can be achieved by using colored Fresnel lenses together with the light emitting elements emitting a similar color. Any technique that results in the desired colors being emitted by the Fresnel lenses can be used.

Returning to FIG. 1, the system 10 also includes a vertical array 30 of lights disposed on and forming the vertical centerline VCL. The vertical array 30 creates a vertical axis or vertical line that is visible to the docking vehicle to better allow the docking vehicle to gauge its position relative to the VCL during alignment. In this example, the array 30 includes two light elements disposed above the array 20 and two light elements disposed beneath the array 20. The light elements of the array 30 and the center lens 26 are aligned with one another along a linear, vertical axis substantially perpendicular to the array 20. The light elements of the array 30 can be any type of light elements that are visible to the docking vehicle at all approach angles, such as incandescent bulbs or LEDs that produce white light.

For covert applications, the light of the array 20 of Fresnel lenses and the vertical array 30 need not be visible to the naked eye. Instead, the light can be in a spectrum that is not visible to the naked eye, such as infrared. Therefore, as used herein, the term “visible” is meant to encompass light that is visible to the naked eye as well as light that is visible using sensors or using aids such as night vision goggles or the like.

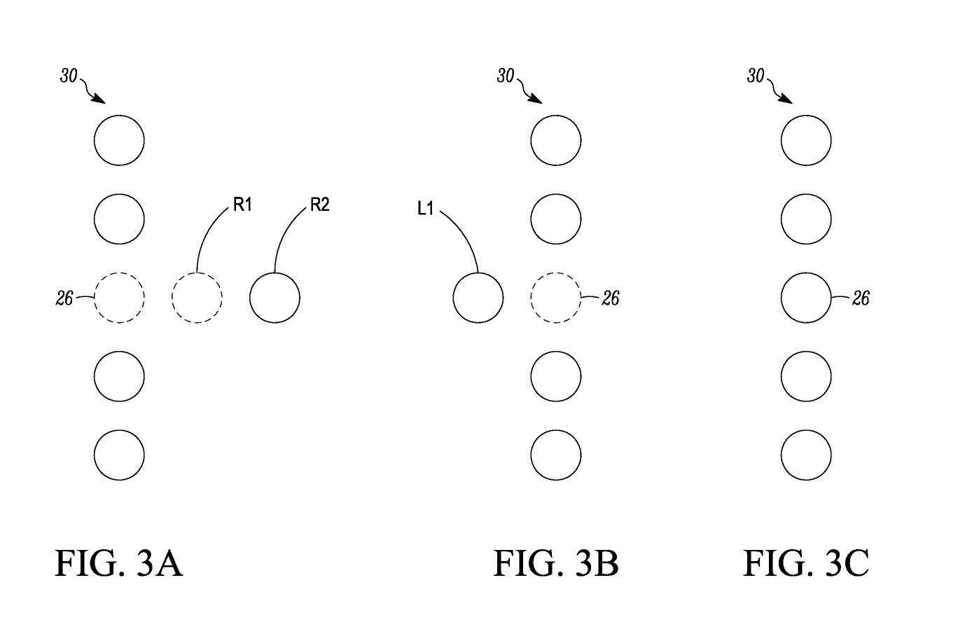

FIG. 3A illustrates an example of a light arrangement from the system 10 seen by the docking vehicle when the docking vehicle is off-center right relative to the VCL. The lights of the vertical array 30 are visible, as is light (which can be blue in color) from the Fresnel lens R2. None of the light from the other Fresnel lenses is visible. The center lens 26 is not visible, and the Fresnel lens R1 is not visible. But by counting the distance of the Fresnel lens R2 from the vertical array 30, the docking vehicle can determine how far right it is relative to the VCL.

FIG. 3B illustrates an example of a light arrangement from the system 10 seen by the docking vehicle when the docking vehicle is off-center left relative to the VCL. The lights of the vertical array 30 are visible, as is light (which can be blue in color) from the Fresnel lens L1. The center lens 26 is not visible. By counting the distance of the Fresnel lens L1 from the vertical array 30, the docking vehicle can determine how far left it is relative to the VCL.

FIG. 3C illustrates an example of a light arrangement from the system 10 seen by the docking vehicle when the docking vehicle is on-center with the VCL. The lights of the vertical array 30 are visible, as is light from the center lens 26. By keeping the light from the center lens 26 visible, the docking vehicle knows that it is properly aligned along the VCL for docking.

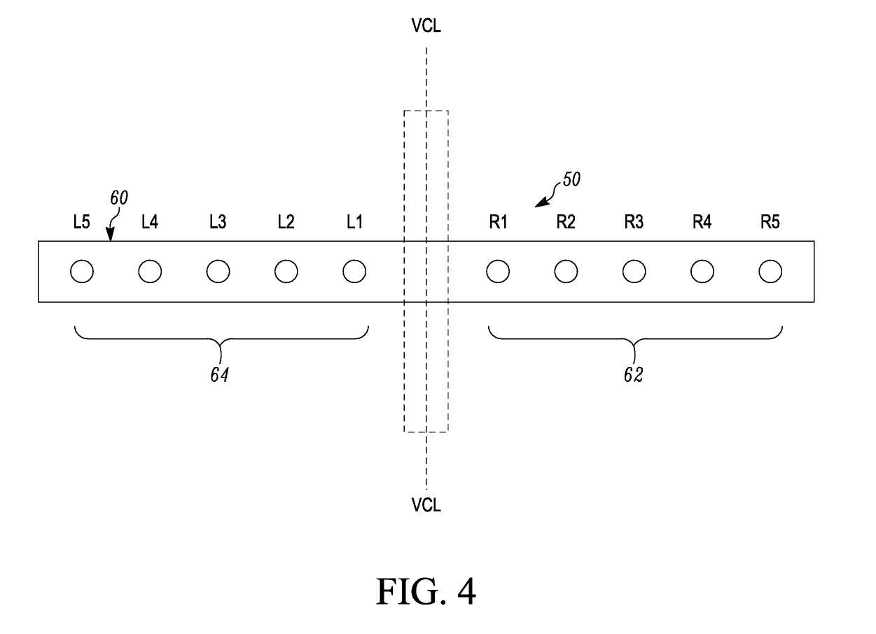

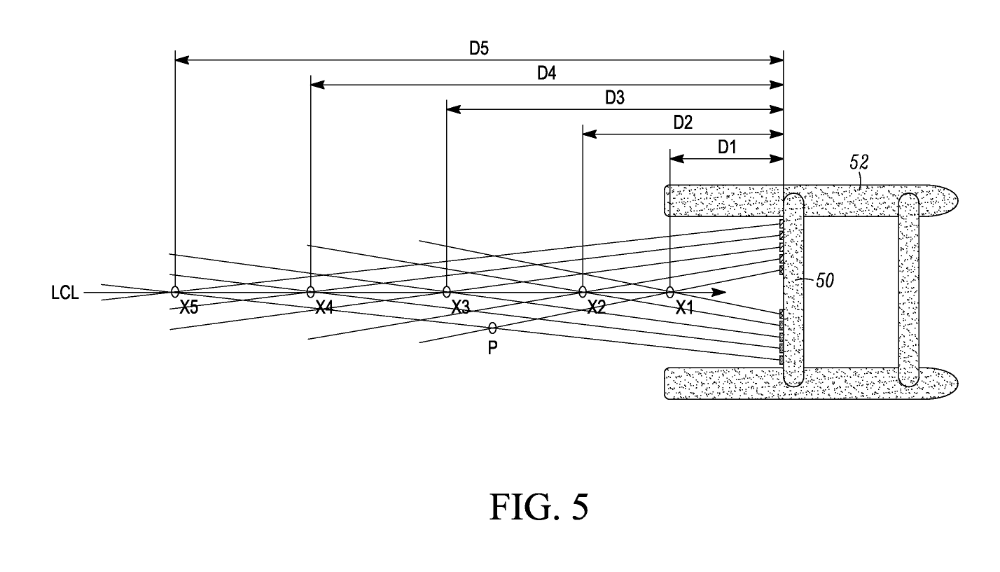

FIGS. 4 and 5 illustrate another embodiment of an optical alignment system 50 that is mounted on a receiving vehicle 52. The system 50 is mounted on the vehicle 52 in any suitable location so that the system 50 is visible to the docking vehicle that will align with the vehicle 52. In the illustrated embodiment, the system 50 is mounted on a portion of the vehicle that is disposed above a waterline. The system 50 can be disposed on the vehicle 52 so that the system 50 is oriented to face in the aft or rearward direction in the case of the docking vehicle being aligned with the vehicle 52 by approaching from the aft. Alternatively, the system 50 can be disposed on the vehicle 52 so that the system is oriented to face in the fore or forward direction in the case of the docking vehicle being aligned with the vehicle 52 by approaching from the front. The system 50 can also be oriented to face in port or starboard directions, or at any orientation facing the direction at which the docking vehicle is intended to approach the vehicle 52 during alignment.

In addition, the system 50 is disposed along a vertical centerline VCL of the vehicle, which in the illustrated example is along a longitudinal centerline LCL of the vehicle. The VCL is just one example of a vertical line along which the system 50 can be disposed. The system 50 can be disposed along any vertical line of the vehicle not necessarily along the longitudinal centerline LCL.

As best seen in FIG. 4, the system 50 includes a horizontal array 60 of Fresnel lenses that are linearly arranged along a horizontal axis. The array 60 includes a first plurality 62 of Fresnel lenses disposed on one side of a vertical centerline VCL (for example the right side) and a second plurality 64 of Fresnel lenses disposed on the opposite side of the vertical centerline VCL (for example the left side).

The Fresnel lenses of the array 60 are arranged in pairs, with one Fresnel lens of the first plurality 62 and one Fresnel lens of the second plurality 64 spaced equidistant from the vertical centerline VCL to form a first pair; one Fresnel lens of the first plurality 62 and one Fresnel lens of the second plurality 64 spaced equidistant from the vertical centerline VCL to form a second pair; etc. In the illustrated example, there are 5 pairs of Fresnel lenses so that there are 12 total Fresnel lenses and 5 Fresnel lens pairs. However, a larger or smaller number of Fresnel lenses and Fresnel lens pairs can be used.

With reference to FIG. 4, the Fresnel lenses in each array 62, 64 can be referred to by their respective positions to the right or left of the VCL. For example, the 1st Fresnel lens to the right of the VCL can be termed R1, the 2nd to the right as R2, etc., while the 1st Fresnel lens to the left of the VCL can be termed L1, the 2nd to the left as L2, etc.

With reference to FIG. 5, the Fresnel lenses of each pair are arranged so that light paths therefrom converge along the longitudinal centerline LCL at different distances behind the array 60. For example, the pair R1, L1 can converge at location X1 a distance D1 behind the array; the pair R2, L2 can converge at location X2 a distance D2 behind the array; the pair R3, L3 can converge at location X3 a distance D3 behind the array; the pair R4, L4 can converge at location X4 a distance D4 behind the array; and the pair R5, L5 can converge at location X5 a distance D5 behind the array. The light beams in FIG. 5 are drawn as rays but they would actually be wedges.

With the construction in FIGS. 4 and 5, as the docking vehicle travels down the centerline LCL, it would see the lights from the Fresnel lenses in matched pairs as it reaches the locations X5 to X1. X1 could form the desired alignment location, with X5 to X2 progressively indicating to the docking vehicle that it is getting closer to the alignment location. In one embodiment, the R1, L1 lenses could emit red light such that when the rid lights are seen, the docking vehicle knows it is at the correct alignment position, for example for subsequent docking. Likewise, the other Fresnel lens pairs could have different colors to help indicate the docking vehicle's progression to the correct position X1.

In the event that the docking vehicle is off set from the LCL, the docking vehicle will see a pair of mismatched lights from the Fresnel lens. For example, if the docking vehicle is at the position P in FIG. 5 (off set to the right of the LCL), the R5, L1 lights are visible. By counting the position of the right Fresnel lens from the VCL, counting the position of the left Fresnel lens from the VCL, and comparing the two, the docking vehicle knows if it is too far right, too far left or on center, as well as how far off center it is. For example, if right is greater than left (e.g. R5 is greater than L1), the docking vehicle is too far right. If left is greater than right (e.g. L3 is greater than R2), the docking vehicle is too far left. If the docking vehicle is on the centerline LCL, R will equal L and the corresponding Fresnel lens pairs will be visible as the docking vehicle progresses from X5 to X4 to X3, etc.

The system 50 can optionally include a vertical light or array of lights similar to the array 30 to indicate the vertical centerline VCL or vertical line/axis.

In each of the systems 10, 50, means for distinguishing the Fresnel lenses of the first plurality from the Fresnel lenses of the second plurality can be provided. For example, the means for distinguishing can be achieved by using different colors or by light shapes (e.g. vertical shaped lights on one side vs. horizontal lights on the other side; rectangle or square lights on one side vs. circular shaped lights on the other side.

In addition, in each of the systems 10, 50, the count to either side of the vertical centerline (e.g. the position of the visible Fresnel lens to the left or right of the vertical axis) can be identified by, for example, using a central, vertical alignment bar or array of lights similar to the array 30; by illuminating the location of every light such as with a ring of white LEDs around the edge of each light such that when the light is visible (i.e. the Fresnel lens permits viewing from that angle) the center of that ring will glow; or by having the various lights be shaped as numbers in a man/machine readable format.

The lights could also flash an encoded message indicating its position relative to the vertical centerline. For example, the fifth light on the left (i.e. L5) could flash a code saying it is the 5th light on the left; etc. The code could be a machine interpretable code or could even be done with Morse code.

### Example Application

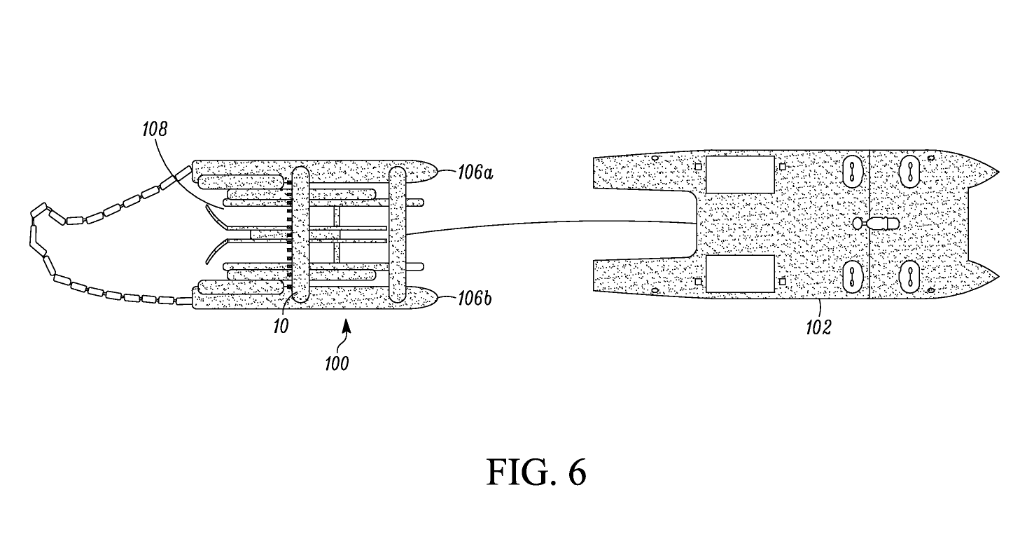

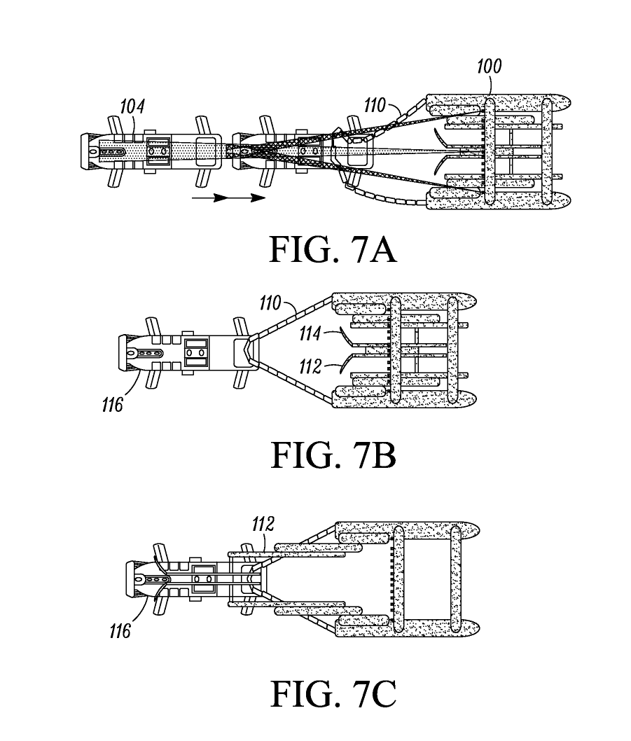

FIG. 6 illustrates an example application of the system 10. The system 50 would function in a generally similar manner. In this example, the system 10 is mounted on a refueling sled 100 that is towed behind a tanker 102, such as a USV. The sled 100 functions as a receiving vehicle that is designed to align and dock with an RMMV 104 as the docking vehicle illustrated in FIGS. 7A-C.

To facilitate the transfer of fuel to an off board sensor platform, such as the RMMV 104, a manned or unmanned vessel such as the tanker 102 can be provided that is capable of deploying a towed surface craft, such as the sled 100, which will mate with the fuel recipient/docking vehicle such as the RMMV 104.

One benefit of using a refueling sled 100 is that it can be towed behind any capable vessel, including a USV or a littoral combat ship. In one embodiment, the sled 100 can be a twin pontoon 106a, 106b style craft as shown in FIGS. 1-5. The dual pontoon design provides a natural receiving location 108 between the pontoons 106a, 106b for docking with and refueling craft with minimized risk of collision. The sled 100 can be adaptable for a variety of USV/UUV vehicles, including the RMMV 104.

With reference to FIGS. 7A-C, a refueling operation will begin with the tanker 102 positioning itself in front of the RMMV 104 (the tanker is not illustrated in FIGS. 7A-C for simplicity). The tanker 102 will reel out the towed refueling sled 100. A human operator, for example located on the tanker 102, can use a remote operator pack (ROP), which is a known joystick like control device, to take control of the RMMV 104 guidance. The operator uses the ROP to steer the RMMV 104 in between the pontoons 106a, 106b of the refueling sled 100 during alignment and docking. In one embodiment, the ROP can be replaced with or supplemented by a device which is able to stream video from a mast camera or other camera on the RMMV 104, to put the operator “on the RMMV” to allow the operator to visualize the approach to the sled 100, while still enabling the driver to control the vehicle with a tactile control including, but not limited to, an NVIDIA Shield or a tablet.

To assist the human driver in centering the RMMV 104 between the pontoons 106a, 106b, and to help position the RMMV 104 in the appropriate fore/aft position, the refueling sled is equipped with the optical alignment system 10 the function and operation of which is described in further detail above.

As described above, the optical alignment system 10 is configured to provide centering information rather than glide slope used by the prior art FLOLS system. The optical alignment system 10 is also able to provide range information so that a mast of the RMMV 104 does not impact the refueling sled 100.

With reference to FIGS. 1, 2, and 7A-C, the RMMV 104 travels down a particular cone of light, in particular the light from the center lens 26, keeping it in view of the camera or other sensor in the case of an unmanned docking vehicle like the RMMV 104, placing the docking vehicle on a specific trajectory. Only one trajectory is aligned to the center lens 26, which as described above can emit green light (a color camera is not required for this to work, but the information added by the colors is helpful when it can be used).

In one example described above, the system 10 contains two flashing red lights at the R6, L6 positions. The light beams from the lights cross at position X at a particular distance D from the sled 100. Only at this distance D, plus or minus some small margin, will both red lights be visible at the same time as seen in FIG. 7A. In this example application, this distance is where the docking RMMV 104 is considered to be properly aligned with the sled 100 and the RMMV 104 would surface and reduce throttle to catch a tow line 110 or other tow feature on the sled 100 as shown in FIG. 7B using a hook or other device on the front of the RMMV 104. In another embodiment, a second set of intersecting red lights (for example non-flashing) could be provided on the system 10 to indicate that the RMMV 104 is close to correct alignment position (similar to the yellow light on a traffic light—it isn't a stop, but it tells you one is coming).

In the case of a refueling operation, once the tow line 110 or other tow feature is caught and the two vehicles are secured, a suitable refueling attachment 112 can be extended from the sled 100 to refuel the RMMV 104 as illustrated in FIG. 7C. The refueling attachment 112 can include a capture spine 114 which is configured to engage with a suitable fueling port 116 on the RMMV 104. The capture spine 114 of the refueling attachment 112 also includes a suitable fuel probe, of a type known in the art, configured to engage the fueling port 116. Examples of fuel probes include, but are not limited to, the fuel probe designs available from Maritime Applied Physics Corporation (Navy SBIR 2008.2, Contract No. N00024-10-C-4130); Naval Surface Warfare Center (Galway), Lockheed Martin HydraLight and CM2000 connector series; and Navatek (Navy SBIR FY2008.2, Proposal No.: N082-177-1093).

The attachment 112 with the capture spine 114 can slide out on rails (illustrated in FIGS. 6-7) or lower on a boom toward the RMMV 104 to make the connection between the capture spine 114 and the RMMV 104.

The capture spine 114 can be attached to a swivel allowing it to adapt to the pitch angle of the vehicles as they move with any waves. The fuel probe mounted on the capture spine 114 extends into a receptacle on the fueling port 116 of the RMMV 104. The probe and receptacle form a watertight seal, though some water infiltration is often unavoidable. Before fuel is transferred into the RMMV 104, a few gallons of fuel are pumped from the RMMV 104 to the tanker 102 to clear any water from the line. This water/fuel mixture is stored separately to be dealt with later. Fuel is then pumped down into the RMMV 104. In one embodiment, since the RMMV 104 is docked with the refueling sled 100, it provides an opportunity to transfer data either wirelessly (short range, high bandwidth) or via a hardwire connection through the fuel probe interface or other suitable interface.

To ensure continued vehicle stability during refueling, the tanker 102 continues to tow the sled 100 at, for example 5-10 knots, and the RMMV 104 control surfaces remain active.

The construction of the optical alignment systems 10, 50 means that relatively simple vision algorithms, operating on a single camera, can be used to permit automated alignment as well as docking in the future. A GPS can be used to provide enough positional accuracy, if the docking and receiving vehicles coordinate/communicate with one another, to bring the docking vehicle within sight of the optical alignment system. From there, a vision-guided autopilot could take over to align and dock the docking vehicle.

In one embodiment, the angles of the two red flashing lights can be changed by mounting these two lights on a controlled servo which would permit dynamic adaptability of the crossing position X and distance D to accommodate multiple vehicle types.

The tow feature for connecting the docking vehicle and the receiving vehicle can be any structure that is suitable for connecting the two vehicles to one another. When the docking and receiving vehicles are water based vehicles, it is desirable that the tow feature is constructed to remove independent surge and sway between the docking vehicle and the receiving vehicle to prevent collisions between the two vehicles.

In one embodiment, the tow line 110 can be a variable rigidity cable as described in copending application Ser. No. ______ (Attorney Docket 20057.0188USU1) titled Variable Rigidity Tow Cable filed on Oct. ______, 2014, the entire contents of which are incorporated herein by reference.

In another embodiment, a rigid towing structure, such as a steel A-frame, can be used to connect the docking vehicle and the receiving vehicle.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. An optical alignment system that aligns a first vehicle with a second vehicle, comprising:
a horizontal array of Fresnel lenses including a first plurality of Fresnel lenses disposed on one side of a vertical line and a second plurality of Fresnel lenses disposed on the opposite side of the vertical line; and
one Fresnel lens of the first plurality and one Fresnel lens of the second plurality are spaced equidistant from the vertical line and form a first pair, and the Fresnel lenses of the first pair are arranged so that light paths therefrom converge along the vertical line at a first distance behind the horizontal array of lights.

2. The optical alignment system of claim 1, wherein the horizontal array is mounted on the second vehicle.

3. The optical alignment system of claim 1, further comprising a vertical array of lights disposed on the vertical line and that forms the vertical line.

4. The optical alignment system of claim 3, further comprising one Fresnel lens of the horizontal array disposed on the vertical line.

5. The optical alignment system of claim 1, wherein the Fresnel lenses of the first pair emit flashing light.

6. The optical alignment system of claim 4, wherein one Fresnel lens of the first plurality and one Fresnel lens of the second plurality are spaced equidistant from the vertical line and form a second pair; one Fresnel lens of the first plurality and one Fresnel lens of the second plurality are spaced equidistant from the vertical line and form a third pair; and the Fresnel lenses of the first pair, the Fresnel lenses of the second pair, the Fresnel lenses of the third pair, and the Fresnel lens disposed on the vertical line emit different colors of light.

7. The optical alignment system of claim 6, wherein the Fresnel lenses of the second pair and the Fresnel lenses of the third pair are arranged so that light paths therefrom diverge from one another.

8. The optical alignment system of claim 1, further comprising one Fresnel lens of the first plurality and one Fresnel lens of the second plurality are spaced equidistant from the vertical line and form a second pair, and the Fresnel lenses of the second pair are arranged so that light paths therefrom converge along the vertical line at a second distance behind the horizontal array of lights, the second distance being different than the first distance.

9. The optical alignment system of claim 8, further comprising one Fresnel lens of the first plurality and one Fresnel lens of the second plurality are spaced equidistant from the vertical line and form a third pair, and the Fresnel lenses of the third pair are arranged so that light paths therefrom converge along the vertical line at a third distance behind the horizontal array of lights, the third distance being different than the first distance and the second distance.

10. The optical alignment system of claim 9, further comprising means for distinguishing the Fresnel lenses of the first plurality from the Fresnel lenses of the second plurality.

11. The optical alignment system of claim 9, further comprising means for determining a count of each Fresnel lens of the first plurality from the vertical line and means for determining a count of each Fresnel lenses of the second plurality from the vertical line.

12. A vehicle that includes the optical alignment system of claim 1 mounted thereon.

13. The vehicle of claim 12, wherein the vehicle is a water vehicle.

14. The vehicle of claim 12, wherein the vertical line is along a centerline of the vehicle.

15. An optical alignment system for aligning a first vehicle with a second vehicle, comprising:
a horizontal array of Fresnel lenses mounted on the second vehicle so as to be visible to the first vehicle;
the horizontal array including a first plurality of Fresnel lenses disposed on one side of a vertical axis and a second plurality of Fresnel lenses disposed on the opposite side of the vertical axis;
one Fresnel lens of the first plurality and one Fresnel lens of the second plurality form a first pair;
one Fresnel lens of the first plurality and one Fresnel lens of the second plurality form a second pair;
one Fresnel lens of the first plurality and one Fresnel lens of the second plurality form a third pair; and
at least one of the following:
a) each Fresnel lens of the first plurality and each Fresnel lens of the second plurality emit coded light that is human or machine readable;
b) the first pair of Fresnel lenses, the second pair of Fresnel lenses, and the third pair of Fresnel lenses are arranged so that light paths from each pair converge at respective convergence locations along a common axis, the convergence locations are at different distances behind the horizontal array.

16. The optical alignment system of claim 15, further comprising a vertical array of lights disposed on the vertical axis, and at least one Fresnel lens of the horizontal array is disposed on the vertical axis.

17. The optical alignment system of claim 15, wherein the Fresnel lenses of at least one of the first, second and third pair emit flashing light.

18. The optical alignment system of claim 15, wherein the Fresnel lenses of at least two of the pairs are arranged so that light paths therefrom diverge from one another.

19. The optical alignment system of claim 15, further comprising means for distinguishing the Fresnel lenses of the first plurality from the Fresnel lenses of the second plurality.

20. The optical alignment system of claim 15, further comprising means for determining a count of each Fresnel lens of the first plurality from the vertical axis and means for determining a count of each Fresnel lenses of the second plurality from the vertical axis.

21. The optical alignment system of claim 15, wherein the coded light comprises one or more of the following:
a) the Fresnel lenses emit differently colored light depending upon their location from the vertical axis;
b) the Fresnel lenses emit flashing light in the form of a code; and
c) the Fresnel lenses have different shapes depending upon their location from the vertical axis.
